(19) United States
(12) Patent Application Publication
(10) Pub. No.: US 2015/0167834 A1
(43) Pub. Date: Jun. 18, 2015

(54) APPARATUS AND METHOD FOR CONTROLLING ELECTRIC OIL PUMP FOR AUTOMATIC TRANSMISSION

(71) Applicant: Hyundai Motor Company, Seoul (KR)

(72) Inventor: Jin Young HWANG, Busan (KR)

(73) Assignee: Hyundai Motor Company, Seoul (KR)

(21) Appl. No.: 14/301,036

(22) Filed: Jun. 10, 2014

(30) Foreign Application Priority Data
Dec. 18, 2013 (KR) 10-2013-0158578

(51) Int. Cl. F16H 61/00

(52) U.S. Cl. CPC F16H 61/0031

(57) ABSTRACT

Disclosed are an apparatus and a method of controlling an electric oil pump for an automatic transmission. The method may include detecting driving information and determining a state of the automatic transmission, dividing the state of the automatic transmission into an in-gear state, a clutch fill time section, and a stroke section, and controlling RPM of a motor in accordance with the in-gear state, the clutch fill time section, and the stroke section, actively adjusting a discharge flow rate of a pump to form a line pressure, and operating a friction element.

### CROSS-REFERENCE TO RELATED APPLICATION

The present application claims priority of Korean Patent Application Number 10-2013-0158578 filed on Dec. 18, 2013, the entire contents of which application are incorporated herein for all purposes by this reference.

### BACKGROUND OF INVENTION

1. Field of Invention

The present invention relates to an apparatus and a method for controlling an electric oil pump for an automatic transmission, and more particularly, to an apparatus and a method for controlling an electric oil pump for an automatic transmission which prevent hydraulic pressure from being decreased during a gear shifting operation so as to prevent a run-up from occurring.

2. Description of Related Art

As improvement in fuel efficiency of a vehicle has been continuously demanded due to global problems with high oil prices, and demands for environmentally-friendly vehicles are increased due to consolidated regulations concerning emission of exhaust gas (CO₂) for each country, vehicle makers have made great effort to develop technologies for reducing fuel consumption in order to satisfy the demands.

The problem to be primarily solved for improving fuel efficiency is to improve an oil pump which is a factor of incurring maximum power loss of a vehicle to which an automatic transmission is applied.

Generally, as an oil pump for a vehicle to which an automatic transmission is applied, a mechanical oil pump, which is operatively connected to a drive shaft of an engine, is applied, but because it is impossible for the mechanical oil pump to autonomously perform RPM control, there is a problem in that oil is supplied more than necessary within a high RPM region such that power is wasted.

In addition, a necessary discharge flow rate needs to be made even at a minimum RPM at a high temperature, and thus there is problem in that a capacity of the oil pump is designed to be greater than a required flow rate within a region that is commercially used.

In order to apply an ISG (Idle Stop & Go) system which stops an engine when the vehicle stops so as to improve fuel efficiency, it is necessary to additionally mount an electric oil pump for supplying hydraulic pressure to the automatic transmission under a condition in which the vehicle moves again after stopping.

Recently, structures in which the mechanical oil pump, which is connected to the drive shaft of the engine, and generates power loss at all times, and causes fuel efficiency to deteriorate, is eliminated, and the electric oil pump is applied to supply oil to the automatic transmission are developed, such that the RPM of the pump is optimally controlled, thereby improving fuel efficiency.

FIG. 4 is a view illustrating an oil supply structure of an electric oil pump for an automatic transmission in the related art. Referring to FIG. 4, typically, when a gear is shifted to any gear shift stage in a state in which a pump 12 is driven by an operation of a motor 11, a solenoid A 13A is operated to release a clutch A 14A that is a release-side friction element, a solenoid B 13B is operated to engage with a clutch B 14B that is an engagement-side friction element, and a solenoid C 13C is operated to maintain a clutch C 14C as it is that is a maintaining friction element.

The following two problems may occur during the aforementioned control.

The first problem is that a consumption flow rate of the solenoid valve is increased in a gear shifting control section such that a flow rate is insufficient, and the second problem is that a required flow rate is increased because oil is supplied to a piston so as to engage the clutch B.

The oil pump is required to supply a large amount of oil because of the aforementioned two problems, but if the electric oil pump is operated under a condition like a constant speed stage, the clutch C (e.g., C1 in FIG. 5), which is a maintaining friction element, is released due to an instantaneous oil consumption during a gear shifting operation in which the clutch A, which is a release-side friction element, is released (A1), and the clutch B, which is an engagement-side friction element, is engaged, thereby incurring a run-up, as can be seen from FIG. 5.

In a case in which the electric oil pump is driven at a maximum RPM at all times in order to prevent the clutch C from being released due to an instantaneous oil consumption during a gear shifting operation, there is a problem in that fuel efficiency and durability deteriorate.

In order to prevent the aforementioned problem, a technology of controlling the electric oil pump so as to increase the RPM of the electric oil pump only when a gear shifting operation is performed is provided, but typically, a degree of increasing the RPM of the electric oil pump is set based on a maximum value of a leakage flow rate of the electric oil pump and a valve body (hydraulic pressure control apparatus), and thus there is a problem in that loss occurs for each oil temperature, and for each product deviation.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to provide an apparatus and a method for controlling an electric oil pump for an automatic transmission, which divide RPM of an electric oil pump into an in-gear state, a clutch fill time section, and a stroke section, and controls the RPM of the electric oil pump so as to prevent hydraulic pressure from being decreased during a gear shifting operation, thereby preventing a run-up from occurring.

Various aspects of the present invention provide an apparatus for controlling an electric oil pump for an automatic transmission, including: the electric oil pump which includes a motor and a pump; a solenoid valve which adjusts a flow rate discharged from the pump to form a line pressure in a flow path; a pressure sensor which detects the line pressure formed in the flow path; a driving information detecting unit which detects a need for driving a vehicle and state information of the vehicle; and a controller which analyzes the need for driving the vehicle and the state information of the vehicle, and according to an operational state of the transmission, divides RPM of the motor into an in-gear state, a clutch fill time section in which an initial operation of an engagement-side friction element which engages a target gear shift stage is performed, and a stroke section in which an actual gear shifting operation is performed, and controls the RPM of the motor to adjust the discharge flow rate of the pump.

In the in-gear state, the controller may control the motor with a first RPM to adjust the discharge flow rate of the pump to supply a hydraulic pressure at a driving condition.

In the clutch fill time section, the controller may control the motor or the solenoid valve or both to supply the line pressure to a flow path which is to be newly filled with oil to engage the target gear shift stage, and control the motor with a second RPM to adjust the discharge flow rate of the pump to supply a flow rate that is required for an initial operation of the engagement-side friction element.

In the stroke section, the controller may control the motor with a third RPM to adjust the discharge flow rate of the pump to fully engage the engagement-side friction element.

The controller may control the discharge flow rate of the pump to follow a target pressure by correcting the RPM of the motor based on information from the pressure sensor which detects the line pressure formed in the flow path.

Various other aspects of the present invention provide a method of controlling an electric oil pump for an automatic transmission, including: detecting driving information and determining a state of the automatic transmission; dividing the state of the automatic transmission into an in-gear state, a clutch fill time section, and a stroke section; and controlling RPM of a motor in accordance with the in-gear state, the clutch fill time section, and the stroke section, actively adjusting a discharge flow rate of a pump to form a line pressure, and operating a friction element.

In the in-gear state of the automatic transmission, the motor may be controlled with a first RPM to adjust the discharge flow rate of the pump at a driving condition.

In the clutch fill time section of the automatic transmission, the motor may be controlled with a second RPM to form the line pressure in a flow path that is newly determined by a need for gear shifting with the discharge flow rate of the pump, and supply an initial operation hydraulic pressure to an engagement-side friction element.

In the stroke section of the automatic transmission, the motor may be controlled with a third RPM to fully engage an engagement-side friction element of a target gear shift stage with the discharge flow rate of the pump.

The RPM of the motor may be corrected to follow a target pressure based on feedback of the line pressure when the RPM of the motor is controlled in accordance with the in-gear state, the clutch fill time section, and the stroke section.

Yet various other aspects of the present invention provide a method of controlling an electric oil pump for an automatic transmission, including: detecting driving information including a vehicle speed, an accelerator pedal, a gear shift stage, and an oil temperature; operating a motor with a first RPM to control a discharge flow rate of a pump when an automatic transmission is in an in-gear state based on analysis of the driving information; operating the motor with a second RPM to control the discharge flow rate of the pump when the automatic transmission is in a clutch fill time section; and operating the motor with a third RPM to control the discharge flow rate of the pump when the automatic transmission is in a stroke section.

The RPM of the motor may be corrected based on a line pressure which is formed in a flow path in adjusting the RPM of the motor and controlling the discharge flow rate of the pump, such that the discharge flow rate of the pump is adjusted.

According to various aspects of the present invention, the electric oil pump is separately controlled in accordance with gear shifting conditions, thereby preventing a run-up from occurring due to an insufficient flow rate, and reducing power loss due to an unnecessary operation.

The present invention corrects initial mapping data of the electric pump by learning the initial mapping data using a pressure sensor, thereby reducing deviation for each product which occurs when an automatic transmission is manufactured, and compensating for the reduction in hydraulic pressure with respect to an increase in leakage amount according to durability of the automatic transmission.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view schematically illustrating an exemplary apparatus for controlling an electric oil pump for an automatic transmission according to the present invention.

FIGS. 2A and 2B are flowcharts illustrating an exemplary procedure of controlling the electric oil pump for an automatic transmission according to the present invention.

FIG. 3 is a view illustrating exemplary control timing of the electric oil pump for an automatic transmission according to the present invention.

FIG. 4 is a view illustrating an oil supply structure of an electric oil pump for an automatic transmission in the related art.

FIG. 5 is a view illustrating a state in which a run-up occurs due to a decrease in hydraulic pressure in an electric oil pump for an automatic transmission in the related art during a gear shifting operation.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

A part irrelevant to the description will be omitted to clearly describe the present invention, and the same or similar elements will be designated by the same reference numerals throughout the specification. In addition, each configuration illustrated in the drawings is shown for understanding and ease of description, but the present invention is not limited thereto.

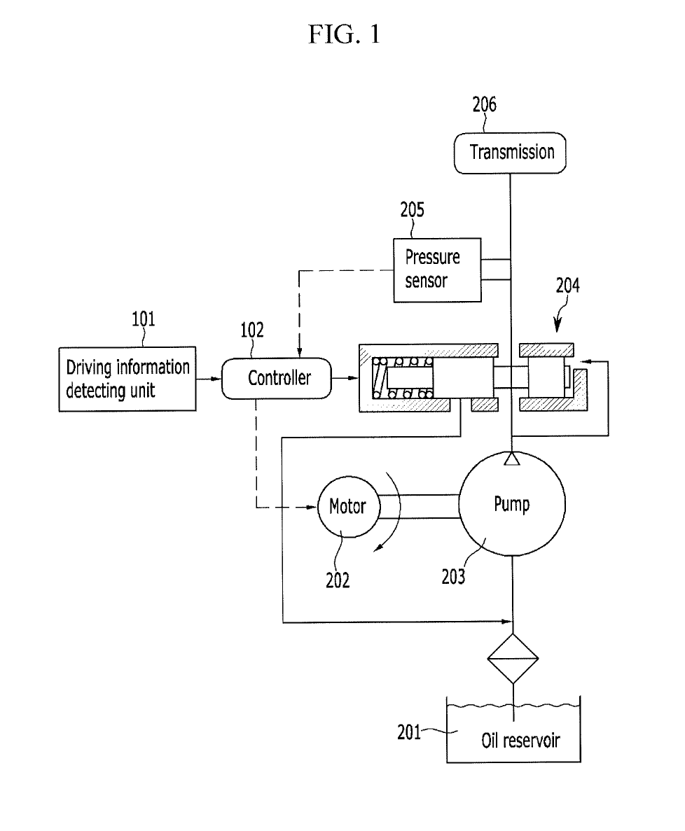

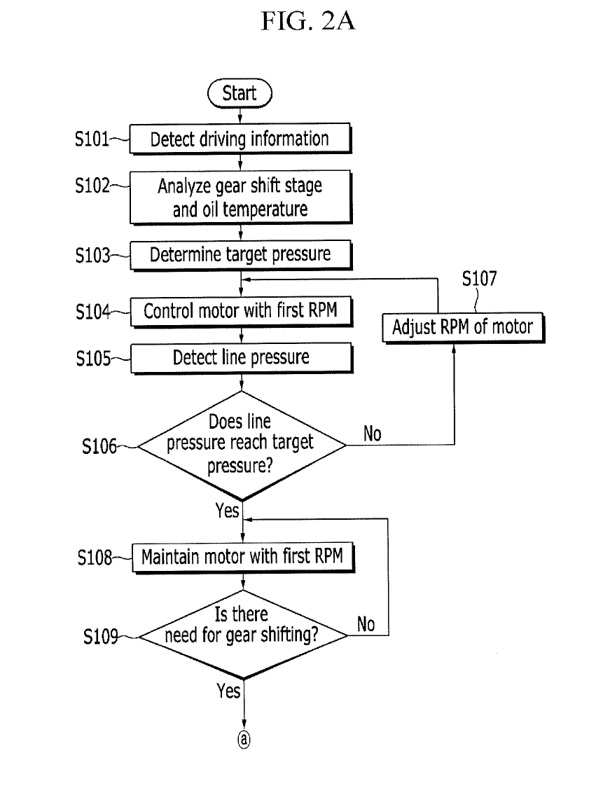

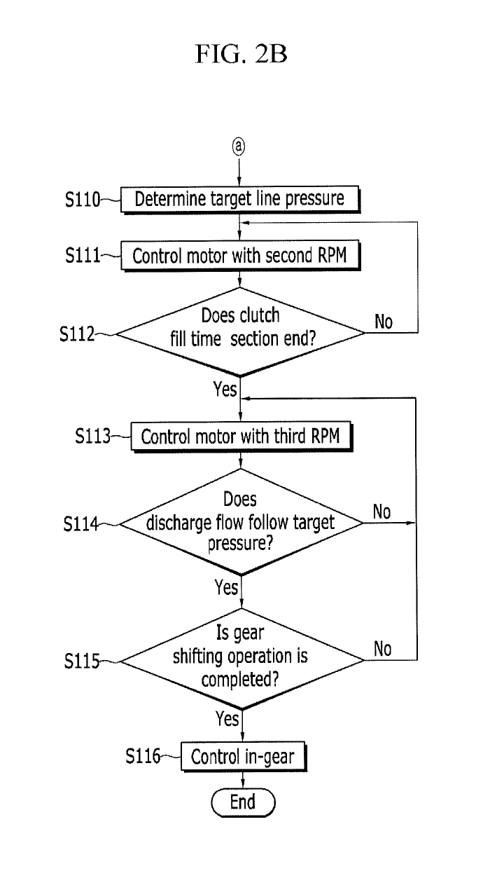

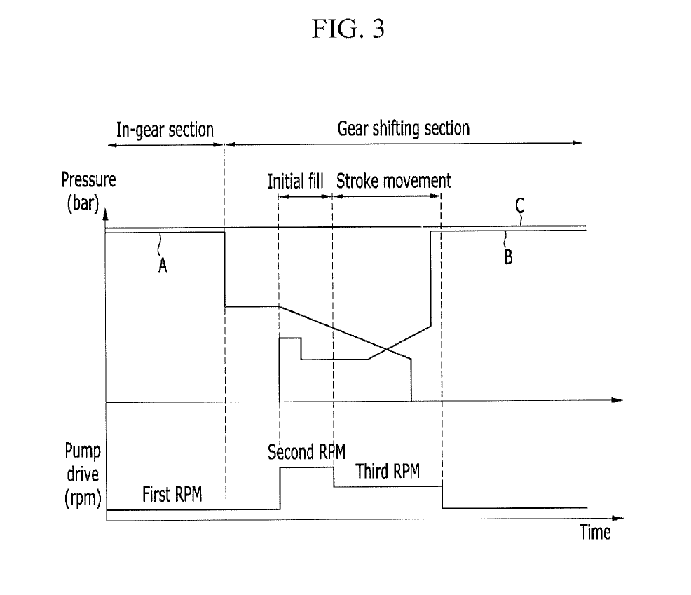

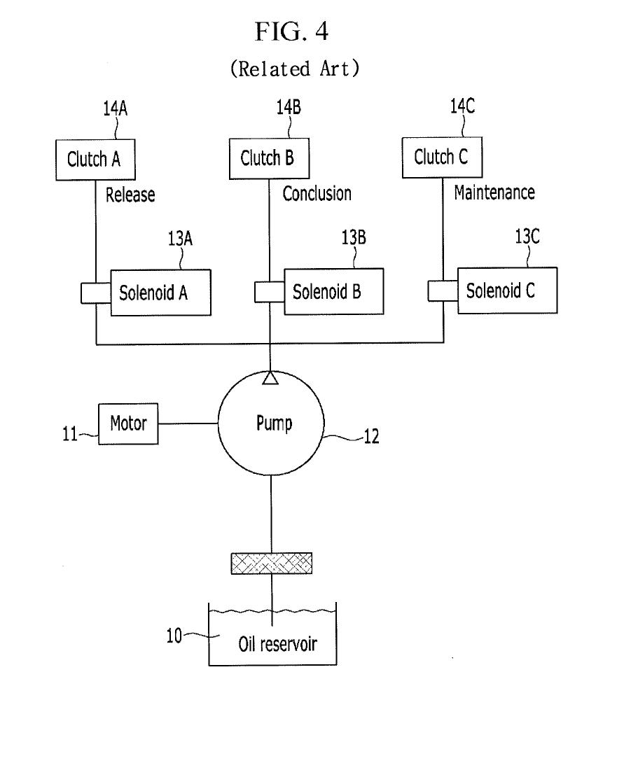

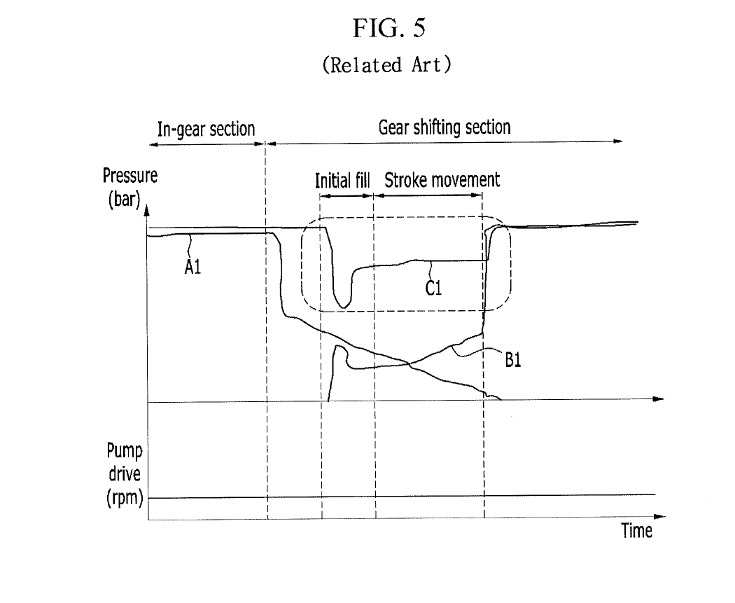

FIG. 1 is a view schematically illustrating an apparatus for controlling an electric oil pump for an automatic transmission according to various embodiments of the present invention. Referring to FIG. 1, the present invention includes a driving information detecting unit 101, a controller 102, an oil reservoir 201, a motor 202, a pump 203, a solenoid valve 204, a pressure sensor 205, and a transmission 206.

The driving information detecting unit 101 detects various driving information including displacement (opening degree) of an accelerator pedal operated by a driver, a vehicle speed that is detected from RPM of an output shaft of the transmission, a gear shift stage that is currently synchronized, an oil temperature that is a temperature of transmission oil, and the like, and provides the driving information to the controller 102.

The controller 102 analyzes the information provided from the driving information detecting unit 101 so as to determine a target gear shift stage, determines target pressure according to a target gear shift stage, adjusts a discharge flow rate of the pump 203 by controlling RPM of the motor 202, and operates the solenoid valve 204 so as to adjust a flow rate (hydraulic pressure) of the oil that is supplied to a release-side friction element, an engagement-side friction element, and a maintaining friction element that are provided in the transmission 206.

According to an operational state of the transmission, the controller 102 divides the RPM of the motor 202 into an in-gear state that is a typical driving condition, a clutch fill time section in which an initial operation of the engagement-side friction element which engages the target gear shift stage is performed according to a gear shifting signal, and a stroke section in which an actual gear shifting operation is performed, and controls the RPM of the motor 202 so as to adjust a discharge flow rate of the pump 203, thereby preventing hydraulic pressure from being decreased during a gear shifting operation.

The controller 102 controls the motor 202 with a first RPM so as to adjust the discharge flow rate of the pump 203 in order to supply hydraulic pressure at a typical driving condition in the in-gear state.

In the clutch fill time section, the controller 102 controls the motor 202 or the solenoid valve 204 or both to supply line pressure to a flow path which is to be newly filled with oil in order to engage the target gear shift stage, and controls the motor 202 with a second RPM so as to adjust the discharge flow rate of the pump 203 in order to supply a flow rate that is required for an initial operation of the engagement-side friction element.

In the stroke section, the controller 102 controls the motor 202 with a third RPM so as to adjust the discharge flow rate of the pump 203 in order to fully engage the engagement-side friction element so as to complete synchronization of the target gear shift stage.

When the synchronization of the target gear shift stage is completed, the controller 102 controls the motor 202 with the first RPM so as to adjust the discharge flow rate of the pump 203, thereby controlling the motor 202 in the in-gear state.

The controller 102 receives information from the pressure sensor 205, which is mounted in a flow path connected with an output end of the solenoid valve 204, as a feedback signal, and corrects the RPM of the motor 202 in accordance with the line pressure formed in the flow path so as to correct the discharge flow rate of the pump 203.

The oil reservoir 201 stores transmission oil that is required to operate the automatic transmission 206.

The motor 202 is driven at a predetermined RPM depending on a control signal that is applied from the controller 102, and operates the pump 203 connected to a rotation shaft so as to adjust the discharge flow rate of the pump 203.

The solenoid valve 204 is operated depending on the control signal that is applied from the controller 102, and adjusts the line pressure formed in the flow path so as to control operations of the release-side friction element, the engagement-side friction element, and the maintaining friction element that are provided in the automatic transmission 206.

The pressure sensor 205 is mounted in the flow path connected with the output end of the solenoid valve 204, detects the discharge flow rate of the pump 203 in accordance with the operation of the motor 202, and the line pressure formed in the flow path in accordance with the operation of the solenoid valve 204, and provides the discharge flow rate and the line pressure to the controller 205.

An operation of the present invention including the aforementioned functions will be described below.

When the vehicle including the automatic transmission having the electric oil pump to which the present invention is applied is driven, the driving information detecting unit 101 detects various driving information including displacement (opening degree) of the accelerator pedal operated by the driver, a vehicle speed that is detected from RPM of the output shaft of the transmission, a gear shift stage that is currently synchronized, an oil temperature that is a temperature of the transmission oil, and the like, and provides the driving information to the controller 102 (S101).

The controller 102 analyzes the gear shift stage and the oil temperature from the information provided from the driving information detecting unit 101 (S102), and determines target pressure that is required to maintain the in-gear state of the gear shift stage that is currently synchronized (S103).

When the target pressure, which is required to maintain the in-gear state, is determined in step S103, the controller 102 controls the motor 202 with the first RPM so as to adjust the discharge flow rate of the pump 203 (S104).

At the same time, the controller 102 operates the solenoid valve 204 so as to allow hydraulic pressure (flow rate) at the in-gear condition to be supplied to the friction element that engages the current gear shift stage in the transmission 206.

The controller 102 receives information about the line pressure that is provided from the pressure sensor 205 (S105), and determines whether the line pressure reaches and follows target pressure (S106).

In a case in which the line pressure does not follow the target pressure in step S106, the controller 102 allows the line pressure to follow the target pressure by adjusting an opening rate of the solenoid valve 204 and the RPM of the motor 202 (S107).

In a case in which the line pressure follows the target pressure in step S106, the controller 102 maintains the motor 202 with the first RPM so as to stably maintain the in-gear state (S108).

In the in-gear state, the controller 102 analyzes the vehicle speed and the displacement of the accelerator pedal, and determines whether a need for gear shifting is detected (S109).

When the need for gear shifting is detected in step S109, the controller 102 determines the target gear shift stage based on the vehicle speed and the displacement of the accelerator pedal, determines the target line pressure for engaging the target gear shift stage, and determines the second RPM of the motor 202 based on the target line pressure (S110).

When the target line pressure for engaging the target gear shift stage is determined in step S110, the controller 102 supplies or controls the line pressure to the flow path which is to be newly filled with oil in order to engage the target gear shift stage, and performs a fill time section control that controls the motor 202 with the second RPM so as to adjust the discharge flow rate of the pump 203 in order to supply a flow rate that is required for an initial operation of the engagement-side friction element (S111).

In a state in which the motor 202 is controlled with the second RPM, the controller 102 corrects the opening rate of the solenoid valve 204 and the second RPM of the motor 202 based on the line pressure detected by the pressure sensor 205.

The controller 102 determines whether the fill time section control, which controls the motor 202 with the second RPM, ends (S112), and in a case in which the fill time section control ends, the controller 102 determines target pressure for stroke section control, and determines the third RPM of the motor 202 based on the target pressure (S113).

The controller 102 controls the motor 202 with the third RPM, and adjusts the discharge flow rate of the pump 203 so as to perform the stroke control that fully engages the engagement-side friction element, and completes synchronization of the target gear shift stage.

The controller 102 receives information from the pressure sensor 205 in a state in which the motor 202 is driven with the third RPM and the stroke control is performed with the discharge flow rate of the pump 203, and determines whether the discharge flow rate follows the target pressure (S114), and in a case in which the discharge flow rate of the pump 203 does not follow the target pressure of the stroke control, the controller 102 allows the discharge flow rate to follow the target pressure of the stroke control by correcting the third RPM of the motor 202.

In a state in which the discharge flow rate of the pump 203 follows the target pressure of the stroke control with the third RPM of the motor 202, the controller 102 determines whether completion of synchronization of the target gear shift stage is detected (S115).

In a case in which the completion of synchronization of the target gear shift stage is not detected, the controller 102 returns the process to step S113, and in a case in which the completion of synchronization of the target gear shift stage is determined, the controller 102 controls the motor 202 with the first RPM so as to adjust the discharge flow rate of the pump 203, thereby controlling the motor 202 in the in-gear state (S116).

When the gear shifting operation is performed as described above, the RPM of the motor is actively controlled depending on conditions such that the discharge flow rate of the pump is actively controlled for each condition, thereby preventing an unnecessary release of the friction element, and preventing a run-up from occurring during the gear shifting operation.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An apparatus for controlling an electric oil pump for an automatic transmission, comprising:
the electric oil pump which includes a motor and a pump;
a solenoid valve which adjusts a flow rate discharged from the pump to form a line pressure in a flow path;
a pressure sensor which detects the line pressure formed in the flow path;
a driving information detecting unit which detects a need for driving a vehicle and state information of the vehicle; and
a controller which analyzes the need for driving the vehicle and the state information of the vehicle, and according to an operational state of the transmission, divides RPM of the motor into an in-gear state, a clutch fill time section in which an initial operation of an engagement-side friction element which engages a target gear shift stage is performed, and a stroke section in which an actual gear shifting operation is performed, and controls the RPM of the motor to adjust the discharge flow rate of the pump.

2. The apparatus of claim 1, wherein:
in the in-gear state, the controller controls the motor with a first RPM to adjust the discharge flow rate of the pump to supply a hydraulic pressure at a driving condition.

3. The apparatus of claim 1, wherein:
in the clutch fill time section, the controller controls the motor or the solenoid valve or both to supply the line pressure to a flow path which is to be newly filled with oil to engage the target gear shift stage, and controls the motor with a second RPM to adjust the discharge flow rate of the pump to supply a flow rate that is required for an initial operation of the engagement-side friction element.

4. The apparatus of claim 1, wherein:
in the stroke section, the controller controls the motor with a third RPM to adjust the discharge flow rate of the pump to fully engage the engagement-side friction element.

5. The apparatus of claim 1, wherein:
the controller controls the discharge flow rate of the pump to follow a target pressure by correcting the RPM of the motor based on information from the pressure sensor which detects the line pressure formed in the flow path.

6. The apparatus of claim 2, wherein:
the controller controls the discharge flow rate of the pump to follow a target pressure by correcting the RPM of the motor based on information from the pressure sensor which detects the line pressure formed in the flow path.

7. The apparatus of claim 3, wherein:
the controller controls the discharge flow rate of the pump to follow a target pressure by correcting the RPM of the motor based on information from the pressure sensor which detects the line pressure formed in the flow path.

8. The apparatus of claim 4, wherein:
the controller controls the discharge flow rate of the pump to follow a target pressure by correcting the RPM of the motor based on information from the pressure sensor which detects the line pressure formed in the flow path.

9. A method of controlling an electric oil pump for an automatic transmission, comprising:
detecting driving information and determining a state of the automatic transmission;
dividing the state of the automatic transmission into an in-gear state, a clutch fill time section, and a stroke section; and
controlling RPM of a motor in accordance with the in-gear state, the clutch fill time section, and the stroke section, actively adjusting a discharge flow rate of a pump to form a line pressure, and operating a friction element.

10. The method of claim 9, wherein:
in the in-gear state of the automatic transmission, the motor is controlled with a first RPM to adjust the discharge flow rate of the pump at a driving condition.

11. The method of claim 9, wherein:
in the clutch fill time section of the automatic transmission, the motor is controlled with a second RPM to form the line pressure in a flow path that is newly determined by a need for gear shifting with the discharge flow rate of the pump, and supply an initial operation hydraulic pressure to an engagement-side friction element.

12. The method of claim 9, wherein:
in the stroke section of the automatic transmission, the motor is controlled with a third RPM to fully engage an engagement-side friction element of a target gear shift stage with the discharge flow rate of the pump.

13. The method of claim 9, wherein:
the RPM of the motor is corrected to follow a target pressure based on feedback of the line pressure when the RPM of the motor is controlled in accordance with the in-gear state, the clutch fill time section, and the stroke section.

14. A method of controlling an electric oil pump for an automatic transmission, comprising:
detecting driving information including a vehicle speed, an accelerator pedal, a gear shift stage, and an oil temperature;
operating a motor with a first RPM to control a discharge flow rate of a pump when an automatic transmission is in an in-gear state based on analysis of the driving information;
operating the motor with a second RPM to control the discharge flow rate of the pump when the automatic transmission is in a clutch fill time section; and
operating the motor with a third RPM to control the discharge flow rate of the pump when the automatic transmission is in a stroke section.

15. The method of claim 14, wherein:
the RPM of the motor is corrected based on a line pressure which is formed in a flow path in adjusting the RPM of the motor and controlling the discharge flow rate of the pump, such that the discharge flow rate of the pump is adjusted.

16. An apparatus for controlling an electric oil pump for an automatic transmission, comprising:
the electric oil pump which includes a motor and a pump;
a pressure sensor which detects a line pressure formed in a flow path;
a driving information detecting unit which detects a need for driving a vehicle and state information of the vehicle; and
a controller which controls the electric oil pump,
wherein the controller is operated by a predetermined program, and actively controls the electric oil pump using the method of claim 9 to prevent a run-up from occurring during a gear shifting operation.

17. An apparatus for controlling an electric oil pump for an automatic transmission, comprising:
the electric oil pump which includes a motor and a pump;
a pressure sensor which detects a line pressure formed in a flow path;
a driving information detecting unit which detects a need for driving a vehicle and state information of the vehicle; and
a controller which controls the electric oil pump,
wherein the controller is operated by a predetermined program, and actively controls the electric oil pump using the method of claim 10 to prevent a run-up from occurring during a gear shifting operation.

18. An apparatus for controlling an electric oil pump for an automatic transmission, comprising:
the electric oil pump which includes a motor and a pump;
a pressure sensor which detects a line pressure formed in a flow path;
a driving information detecting unit which detects a need for driving a vehicle and state information of the vehicle; and
a controller which controls the electric oil pump,
wherein the controller is operated by a predetermined program, and actively controls the electric oil pump using the method of claim 11 to prevent a run-up from occurring during a gear shifting operation.

19. An apparatus for controlling an electric oil pump for an automatic transmission, comprising:
the electric oil pump which includes a motor and a pump;
a pressure sensor which detects a line pressure formed in a flow path;
a driving information detecting unit which detects a need for driving a vehicle and state information of the vehicle; and
a controller which controls the electric oil pump,
wherein the controller is operated by a predetermined program, and actively controls the electric oil pump using the method of claim 12 to prevent a run-up from occurring during a gear shifting operation.

20. An apparatus for controlling an electric oil pump for an automatic transmission, comprising:
the electric oil pump which includes a motor and a pump;
a pressure sensor which detects a line pressure formed in a flow path;
a driving information detecting unit which detects a need for driving a vehicle and state information of the vehicle; and
a controller which controls the electric oil pump,
wherein the controller is operated by a predetermined program, and actively controls the electric oil pump using the method of claim 13 to prevent a run-up from occurring during a gear shifting operation.
